(19) United States
(12) Patent Application Publication
(10) Pub. No.: US 2026/0107055 A1
(43) Pub. Date: Apr. 16, 2026

(54) ELECTRONIC DEVICE

(71) Applicant: CANON KABUSHIKI KAISHA, Tokyo (JP)

(72) Inventor: RYOSUKE TANAKA, Tokyo (JP)

(21) Appl. No.: 19/341,891

(22) Filed: Sep. 26, 2025

(30) Foreign Application Priority Data
Oct. 16, 2024 (JP) 2024-181301

(51) Int. Cl. H04N 23/62; H04N 23/61; H04N 23/667

(52) U.S. Cl. CPC H04N 23/62; H04N 23/61; H04N 23/667

(57) ABSTRACT

An electronic device according to the present disclosure includes a processor, and a memory storing a program which, when executed by the processor, causes an electronic device to execute a determination process of determining a tactile sense to be presented based on a plurality of data regarding imaging, wherein, in the determination process, a different tactile sense is determined as the tactile sense to be presented depending on an imaging situation.

### BACKGROUND

### Field of the Technology

The present disclosure relates to an electronic device, and particularly, to a technique for presenting a tactile sense.

### Description of the Related Art

Techniques for presenting various tactile senses to users have been proposed. Techniques for presenting a sense of force by vibration, pressure, or the like, techniques for presenting a surface shape by deforming or displacing an object, techniques for presenting a sense of temperature by temperature, and the like have been proposed. In such tactile sense presentation, users can intuitively ascertain information rather than visual or auditory information presentation.

Japanese Patent Laid-Open No. 2015-65616 discloses an imaging device that presents a tactile sense indicating a focus state of an object to a user based on frequency components (edge information and high-frequency components) of a captured image. Users touch touch panels with their fingers to select objects (target objects) to be focused while confirming captured images on displays. Imaging devices repeat operation of performing a focusing operation on a selected target object, extracting edge information and high-frequency components of the target object from the captured image, generating tactile information, and presenting a tactile sense. Accordingly, users can confirm in-focus states of target objects by tactile senses when performing imaging (image recording).

However, in an imaging device described in Japanese Patent Laid-Open No. 2015-65616, a tactile sense indicating an edge (contour) is presented based on edge information and high-frequency components of a captured image. In the case of out-of-focus, the tactile sense is not presented or is weakly presented. Therefore, it is difficult for a user to ascertain (recognize) the out-of-focus state, how much a focal position is shifted, what is a target of the focusing operation, and the like.

Since a time in which a user touches a touch panel to select an object is generally short, a focusing operation is completed after the user releases her or his finger from the touch panel. Therefore, the user cannot obtain useful information regarding focusing (final result of the focusing operation). This problem is significant when the focusing operation is slow.

Further, for example, when imaging is performed under an environment where brightness changes, characteristics of a captured image change. Therefore, even when the degree of focus does not change, stable tactile sense presentation cannot be performed, for example, the presented tactile sense changes.

### SUMMARY

The present disclosure provides a technique for enabling useful tactile sense presentation.

The present disclosure in its first aspect provides an electronic device including a processor, and a memory storing a program which, when executed by the processor, causes an electronic device to execute a determination process of determining a tactile sense to be presented based on a plurality of data regarding imaging, wherein, in the determination process, a different tactile sense is determined as the tactile sense to be presented depending on an imaging situation.

The present disclosure in its second aspect provides an electronic device including a processor, and a memory storing a program which, when executed by the processor, causes an electronic device to execute a determination process of determining a tactile sense to be presented by combining a first tactile sense that is based on a feature of an object in a captured image and a second tactile sense that is determined in advance for the object and has a higher degree of abstraction than the first tactile sense, wherein, in the determination process, a tactile sense that is closer to the first tactile sense as sharpness of the object in the captured image is higher and is closer to the second tactile sense as the sharpness is lower is determined as the tactile sense to be presented.

The present disclosure in its third aspect provides a control method of an electronic device, including acquiring a plurality of data regarding imaging, and determining a tactile sense to be presented based on the plurality of data, wherein, a different tactile sense is determined as the tactile sense to be presented depending on an imaging situation.

The present disclosure in its fourth aspect provides a non-transitory computer readable medium that stores a program, wherein the program causes a computer to execute a control method of an electronic device, the control method including acquiring a plurality of data regarding imaging, and determining a tactile sense to be presented based on the plurality of data, wherein, a different tactile sense is determined as the tactile sense to be presented depending on an imaging situation.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a hardware configuration of an imaging device according to a first embodiment.

FIG. 2 is a diagram illustrating a functional configuration of the imaging device according to the first embodiment.

FIG. 3 is a diagram illustrating an operation of the imaging device according to the first embodiment.

FIG. 4 is a diagram illustrating a hardware configuration of an imaging system according to a second embodiment.

FIG. 5 is a diagram illustrating a functional configuration of the imaging system according to the second embodiment.

FIG. 6 is a diagram illustrating an operation of the imaging system according to the second embodiment.

### DESCRIPTION OF THE EMBODIMENTS

Hereinafter, two embodiments of the present disclosure will be described. In the following embodiments, similarly to the techniques of the related art, a focusing target (a target object of a focusing operation) is selected using a touch panel, and a focusing operation is performed and tactile sense presentation is performed. A first embodiment is an example in which only an imaging device is used, and a second embodiment is an example in which an imaging device and an operation device are used.

### First Embodiment

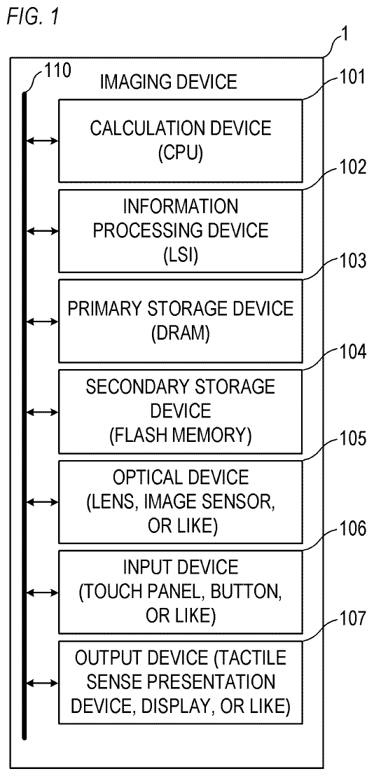

A first embodiment will be described. FIG. 1 is a block diagram illustrating a hardware configuration of an imaging device 1 according to the first embodiment. The imaging device 1 is a smartphone, a digital camera, or the like and includes a calculation device 101, an information processing device 102, a primary storage device 103, a secondary storage device 104, an optical device 105, an input device 106, an output device 107, and a bus 110. The calculation device 101 is a central processing unit (CPU) or the like, and the information processing device 102 is an information processing large-scale integration (LSI) or the like. The primary storage device 103 is a volatile main storage device or the like, and the secondary storage device 104 is a nonvolatile auxiliary storage device or the like. The optical device 105 is a lens, an image sensor, or the like, the input device 106 is a touch panel, a button, or the like, and the output device 107 is a tactile sense presentation device, a display, or the like.

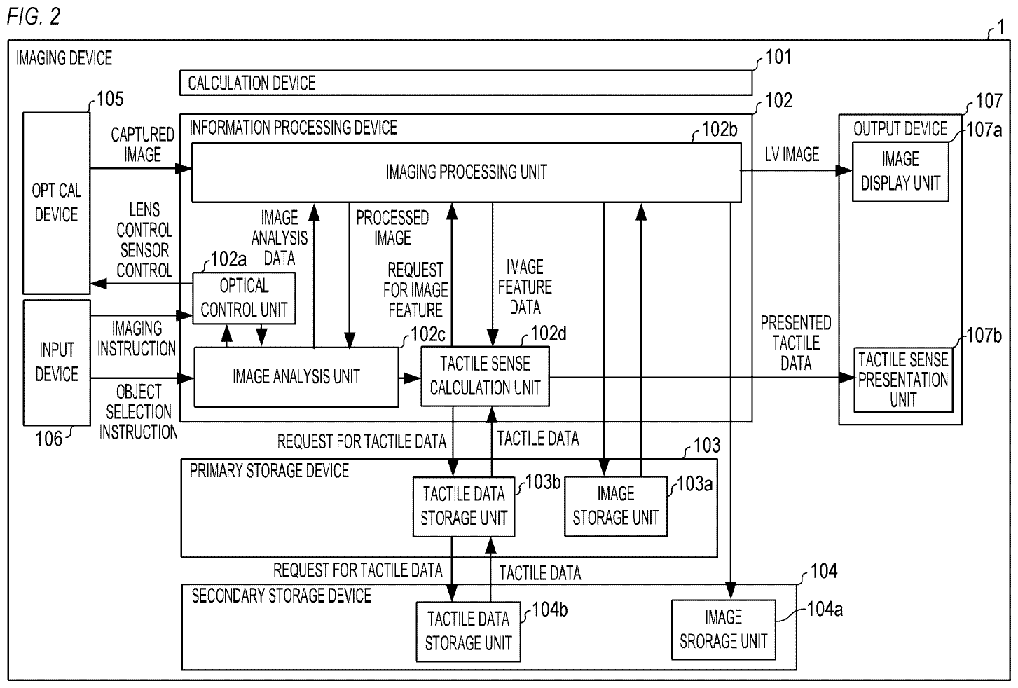

FIG. 2 is a block diagram illustrating a hardware configuration, a functional configuration, and data transmission and reception of the imaging device 1 according to the first embodiment.

The calculation device 101 controls other hardware. Operations, parameters, and the like of constituents illustrated in FIG. 2 are controlled by the calculation device 101.

The information processing device 102 includes an optical control unit 102a, an image processing unit 102b, an image analysis unit 102c, and a tactile sense calculation unit 102d. The optical control unit 102a performs control for imaging and focusing (control of a lens and an image sensor). The image processing unit 102b performs a process using an image (captured image) or the like captured by the optical device 105. The image analysis unit 102c analyzes an image before or after the process by the image processing unit 102b. The tactile sense calculation unit 102d generates tactile data (tactile information) indicating a tactile sense to be presented.

The primary storage device 103 includes an image storage unit 103a and a tactile data storage unit 103b. The image storage unit 103a and the tactile data storage unit 103b temporarily store image data, the tactile data, and the like to be used by the calculation device 101 and the information processing device 102.

The secondary storage device 104 includes an image storage unit 104a and a tactile data storage unit 104b. The image storage unit 104a and the tactile data storage unit 104b store image data, tactile data, and the like used by the calculation device 101 and the information processing device 102.

The optical device 105 performs imaging, driving of a lens regarding a focusing operation, and the like.

The input device 106 inputs an instruction from a user to the calculation device 101 and the information processing device 102.

The output device 107 includes an image display unit 107a and a tactile sense presentation unit 107b. The image display unit 107a displays an image processed by the information processing device 102, various types of information, and the like. The tactile sense presentation unit 107b presents a tactile sense based on the tactile data generated by the information processing device 102 to the user. A method of presenting the tactile sense by the tactile sense presentation unit 107b is not particularly limited, and various known presentation methods can be used. For example, the tactile sense presentation unit 107b may be a vibrator that presents a tactile sense by vibration. The tactile sense presentation unit 107b may present a particle size such as smoothness and roughness, hardness, and the like. The tactile sense presentation unit 107b may present a temperature.

Each constituent of the imaging device 1 can exchange data via the bus 110.

An operation of the imaging device 1 according to the first embodiment will be described. The operation of the imaging device 1 includes the following four stages. LV imaging and display, focus control, and imaging (image recording) are similar to operations of a general digital camera. The first embodiment is characterized by calculation and presentation of a tactile sense.
Live view (LV) imaging and display
In-focus control
Calculation and presentation of tactile sense
Imaging (image recording)

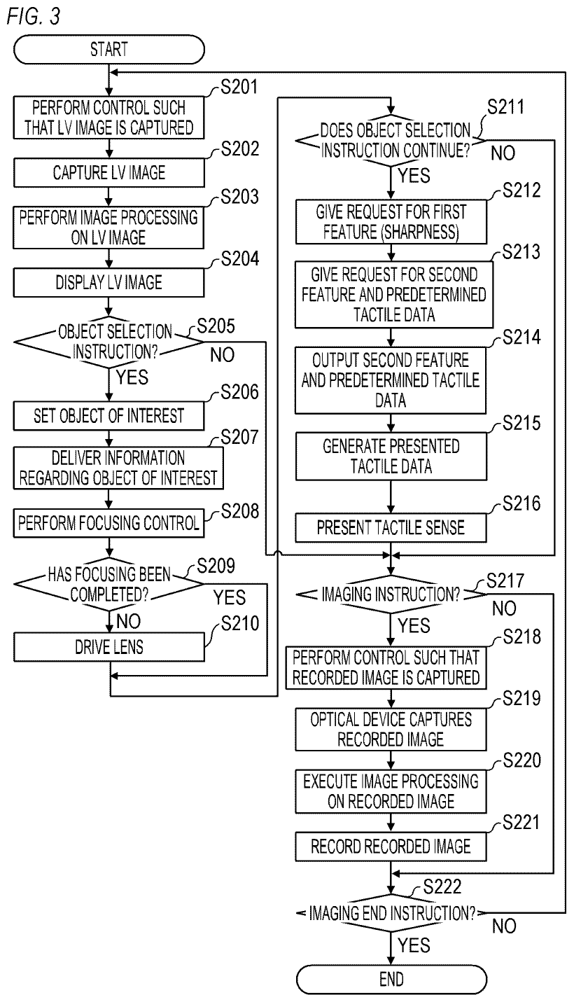

FIG. 3 is a flowchart illustrating an operation of the imaging device 1 according to the first embodiment. When the user operates the input device 106 such as a button or a switch and an operation mode of the imaging device 1 transitions to an imaging mode, the operation of FIG. 3 starts.

An operation of steps S201 to S204 is an operation related to LV imaging and display.

In step S201, the optical control unit 102a of the information processing device 102 controls the optical device 105 such that an LV image is captured.

In step S202, the optical device 105 captures the LV image.

In step S203, the image processing unit 102b of the information processing device 102 performs predetermined image processing on the LV image.

In step S204, the image display unit 107a of the output device 107 displays the LV image subjected to the image processing in step S203.

An operation of steps S205 to S210 is an operation related to focus control.

In step S205, the calculation device 101 determines whether an object selection instruction has been given to the input device 106. The object selection instruction is a user instruction to select an object to be focused, and is implemented by touching the touch panel so that the object in the displayed LV image is touched. When the object selection instruction has been given, the process proceeds to step S206. When the object selection instruction has not been given, the process proceeds to step S217.

In step S206, the image analysis unit 102c and the image processing unit 102b of the information processing device 102 set an object of interest that is a focusing target object by analyzing and processing the LV image. A method of setting the object of interest is not particularly limited, and the object of interest can be set using any of various known object recognition processes. The object recognition process may be a process in which a trained model obtained by machine learning is used.

In step S207, the image analysis unit 102c of the information processing device 102 outputs information regarding the object of interest to the optical control unit 102a. The information to be output includes, for example, distance information (distance data) from the imaging device 1 to the object of interest.

In step S208, the optical control unit 102a of the information processing device 102 calculates a lens control amount for focusing, and outputs the lens control amount to the optical device 105. The type of focusing operation may be autofocus in which the optical control unit 102a automatically calculates the lens control amount for focusing or manual focus in which the user directly inputs the lens control amount.

In step S209, the calculation device 101 determines whether the focusing operation has been completed. When the focusing has not been completed, the process proceeds to step S210. When the focusing operation has been completed, the process proceeds to step S211. A process after step S211 is performed not only when the focusing operation has been completed but also when the focusing operation (focusing control) is being performed. A process after step S211 is performed in parallel with the focusing operation.

In step S210, the optical device 105 drives the lens by a driving amount corresponding to the lens control amount obtained in step S208.

An operation of steps S211 to S216 is an operation related to tactile sense calculation and presentation.

In step S211, the calculation device 101 determines whether an object selection instruction (touch) on the input device 106 continues. When the object selection instruction continues, the process proceeds to step S212. When the object selection instruction does not continue, the process proceeds to step S217.

In step S212, the tactile sense calculation unit 102d of the information processing device 102 gives a request for first feature data regarding sharpness of the object of interest in the LV image (captured image) to the image processing unit 102b. For example, as the first feature data, feature data indicating the degree of focus of the object of interest is requested. The first feature data may be data regarding a feature of the object of interest, and is not limited to the feature data regarding the sharpness and the degree of focus. For example, the first feature data may be feature data regarding the degree of blur, exposure, sensitivity, a noise level, contrast, the degree of aberration, an image resolution, the degree of abstraction, or the like of the object of interest. When the first feature data indicates a plurality of types of features, the tactile sense calculation unit 102d may calculate sharpness of the object of interest using the plurality of types of features. At that time, the sharpness may be calculated using a specific feature such as the degree of focus, and the calculated sharpness may be adjusted (corrected) using the remaining features.

In step S213, the tactile sense calculation unit 102d of the information processing device 102 gives a request for the second feature data regarding the feature of the object of interest in the LV image (captured image) to the image processing unit 102b. Further, the tactile sense calculation unit 102d gives a request for tactile data to the tactile data storage unit 103b of the primary storage device 103 or the tactile data storage unit 104b of the secondary storage device 104. The request to the secondary storage device 104 may be given via the primary storage device 103.

The second feature data is, for example, object recognition result data of the object of interest (data indicating an object recognition result such as a category, a size, a position, and a direction of an object of interest), color data, luminance (brightness) data, edge data, shape data, and the like. The distance data from the imaging device 1 to the object of interest may be acquired as at least a part of the second feature data or as data different from the second feature data.

A plurality of pieces of tactile data corresponding to a plurality of categories of objects are determined in advance, and the tactile data requested to the primary storage device 103 and the secondary storage device 104 is predetermined tactile data corresponding to the category of the object of interest. The tactile data is, for example, data regarding surface characteristics and indicates vibration intensity, a vibration frequency, a vibration time, and the like when a tactile sense is presented by vibration. The predetermined tactile data is generated in advance using, for example, a trained model obtained by machine learning.

In step S214, the image processing unit 102b of the information processing device 102 outputs the second feature data to the tactile sense calculation unit 102d in response to the request of step S213. One of the tactile data storage unit 103b of the primary storage device 103 and the tactile data storage unit 104b of the secondary storage device 104 outputs predetermined tactile data to the tactile sense calculation unit 102d in response to the request of step S213.

In step S215, the tactile sense calculation unit 102d of the information processing device 102 converts the second feature data input from the image processing unit 102b in step S214 into tactile data. Then, the tactile sense calculation unit 102d combines the tactile data obtained by converting the second feature data with the predetermined tactile data input from the primary storage device 103 or the secondary storage device 104 in step S214 based on the sharpness (first feature data regarding the sharpness). Through the combination, presented tactile data is generated.

For example, when the tactile sense is presented by vibration, the tactile sense calculation unit 102d determines the vibration intensity according to the intensity of an edge in the LV image, determines the vibration frequency according to the image frequency, and determines the vibration time according to the distance between the imaging device 1 and the object of interest. Accordingly, the second feature data is converted into tactile data indicating the vibration intensity, the vibration frequency, and the vibration time. The conversion may be performed using a table indicating a correspondence relationship among the edge intensity, the image frequency, and the distance and the vibration intensity, the vibration frequency, and the vibration time, or may be performed using a calculation formula such as multiplication of the edge intensity, the image frequency, and the distance by a predetermined weight. As the conversion from the second feature data to the tactile data, advanced conversion (for example, conversion further using object recognition result data, color data, luminance data, shape data, and the like) may be performed. When a temperature is presented, the temperature to be presented may be determined using color data or luminance data. The conversion from the second feature data to the tactile data is performed for each coordinate of the object of interest. A region (each coordinate) of the object of interest can be determined using image recognition result data, color data, luminance data, shape data, and the like.

The presented tactile data is final tactile data used to control the tactile sense presentation unit 107b to present a tactile sense. When the tactile sense is presented by vibration, the presented tactile data indicating vibration intensity, a vibration frequency, a vibration time, and the like is generated for each coordinate of an image to be displayed.

In the region of the object of interest, a value of the presented tactile data is calculated using, for example, the following calculation formula. In the following calculation formula, Vi1 is a vibration intensity indicated by predetermined tactile data from the primary storage device 103 or the secondary storage device 104. Vf1 is a vibration frequency indicated by predetermined tactile data. Vt1 is a vibration time indicated by the predetermined tactile data. Vi2 is a vibration intensity indicated by the tactile data obtained by converting the second feature data. Vf2 is a vibration frequency indicated by the tactile data obtained by converting the second feature data. Vt2 is a vibration time indicated by the tactile data obtained by converting the second feature data. α is a value obtained by normalizing sharpness, the degree of focus, or the like such that a maximum value is 1. ViO is vibration intensity indicated by the presented tactile data. VfO is a vibration frequency indicated by the presented tactile data. VtO is a vibration time indicated by the presented tactile data. According to the following calculation formula, ViO is calculated by combining Vi1 and Vi2 with weights based on a, and VfO and VtO are calculated through similar weighted combination. For a region other than the region of the object of interest, for example, ViO=VfO=VtO=0 is set.

$$ViO = ( 1 - α ) \times Vi 1 + α \times Vi 2$$

$$VfO = ( 1 - α ) \times Vf 1 + α \times Vf 2$$

$$VtO = ( 1 - α ) \times Vt 1 + α \times Vt 2$$

According to the above calculation formula, as ViO, VfO, and VtO, values closer to Vi1, Vf1, and Vt1 are obtained as the sharpness and the degree of focus are lower. Values closer to Vi2, Vf2, and Vt2 are obtained as the sharpness and the degree of focus are higher. In the first embodiment, Vi1, Vf1, and Vt1 are generalized values having higher degrees of abstraction than Vi2, Vf2, and Vt2. ViO, VfO, and VtO correspond to a presented tactile sense, Vi1, Vf1, and Vt1 correspond to a tactile sense having a high degree of abstraction, and Vi2, Vf2, and Vt2 correspond to a tactile sense based on a feature of a target object in the LV image.

By using the presented tactile data generated in this way, it is possible to present a tactile sense that is easy for the user to sense in both cases where the degree of focus is high and low, and the degree of abstraction of the presented tactile sense changes depending on a change in the degree of focus. Therefore, the user can be allowed to ascertain the degree of focus not only when the object of interest is in focus but also when the object of interest is not in focus. The user can also be allowed to ascertain whether the object of interest has been set correctly, or the user can also be allowed to ascertain what the object of interest is when the object of interest has not been set correctly. The user can also be allowed to intuitively ascertain a change in the degree of focus.

A method of generating presented tactile data (a method of determining a presented tactile sense) is not limited to the above method. For example, the data to be used to generate the presented tactile data and the method of generating the presented tactile data may be changed depending on a type of feature indicated by the first feature data, a type of tactile sense to be presented, or the like. As the predetermined tactile data, fixed data independent of an object (fixed pattern tactile data) may be used. When the presented tactile data is repeatedly generated, the method of generating the presented tactile data may be changed continuously or stepwise. The presented tactile data is not limited to data indicating vibration intensity, a vibration frequency, and a vibration time. Data indicating various types of information such as a frequency, a phase, granularity, hardness, a temperature, characteristics, a presentation amount, and a presentation time of a tactile sense may be used as presented tactile data. A presentation amount corresponds to an amount of energy presented per predetermined time.

The description returns to FIG. 3. In step S216, the tactile sense presentation unit 107b of the output device 107 presents a tactile sense based on the presented tactile data generated in step S215.

An operation of steps S217 to S221 is an operation related to imaging (image recording).

In step S217, the calculation device 101 determines whether an imaging instruction has been given to the input device 106. When the imaging instruction has been given, the process proceeds to step S218. When the imaging instruction has not been given, the process proceeds to step S222.

In step S218, the optical control unit 102a of the information processing device 102 controls the optical device 105 such that a recorded image is captured.

In step S219, the optical device 105 captures a recorded image. The recorded image may be a still image or a moving image.

In step S220, the image processing unit 102b of the information processing device 102 performs predetermined image processing on the recorded image.

In step S221, the information processing device 102 records the recorded image subjected to the image processing in step S220 in the image storage unit 104a of the secondary storage device 104.

In step S222, the calculation device 101 determines whether an imaging end instruction has been given to the input device 106. When the imaging end instruction has been given, the calculation device 101 ends the imaging mode, and the operation of FIG. 3 ends. When the imaging end instruction has not been given, the process proceeds to step S201.

According to the above-described first embodiment, different tactile senses are determined as tactile senses to be presented based on a plurality of pieces of data depending on an imaging situation. In this way, it is possible to perform useful tactile sense presentation. For example, when the object of interest is not in focus, a tactile sense that has a high degree of abstraction prepared in advance is determined. When the object of interest is in focus, a tactile sense corresponding to the feature of the object of interest in the LV image (a tactile sense true to the feature of the object of interest) can be determined. As a result, even when the object of interest is not in focus or when a time is required for a focusing operation, it is possible to perform useful tactile sense presentation that allows the user to ascertain the object of interest and the degree of focus of the object of interest.

According to the calculation formula of the presented tactile data described above, when the imaging situation (first feature data) changes, the presented tactile sense continuously changes with respect to the change in the imaging situation, but the present disclosure is not limited thereto. When the imaging situation changes, the presented tactile sense may change stepwise with respect to the change in the imaging situation.

The imaging situation is not limited to the first feature data and may be a mode of the imaging device 1, a driving situation of the imaging device 1, a setting of the imaging device 1, processing content of the imaging device 1, or the like. The mode of the imaging device 1 is a focus mode, an exposure mode, and the like. For example, presented tactile data different between a case where the focus mode is the focus mode and a case where the focus mode is the manual focus mode may be generated. When the exposure mode is a diaphragm priority mode, the presented tactile data may be generated using a diaphragm value. The driving situation of the imaging device 1 is, for example, a driving situation of the optical device 105 indicating progress of the focusing operation. By considering (referring to) the driving situation of the optical device 105 indicating the progress of the focusing operation, it is possible to generate presented tactile data matching the progress of the focusing operation without analyzing the captured image. The setting of the imaging device 1 is, for example, states (imaging conditions) of various parameters including parameters for designating modes of the imaging device 1. The processing content of the imaging device 1 corresponds to, for example, a program used in the imaging device 1.

### Second Embodiment

A second embodiment will be described. In the following description, configurations and processes similar to those of the first embodiment will not be described, and configurations and processes different from those of the first embodiment will be described.

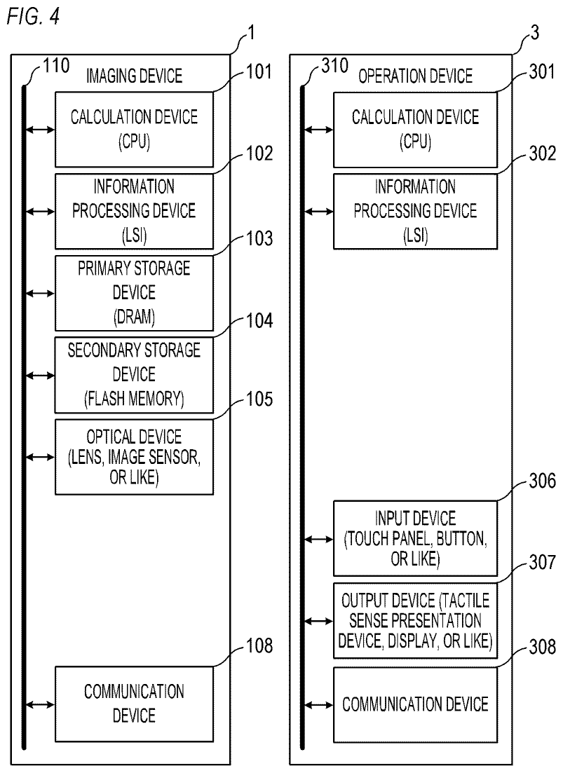

FIG. 4 is a block diagram illustrating a hardware configuration of an imaging system according to the second embodiment. The imaging system includes an imaging device 1 and an operation device 3. The imaging device 1 is a robot, a drone, or the like having an imaging function, and the operation device 3 is an external apparatus of the imaging device 1 and is a controller of the imaging device 1. A smartphone may be used as the imaging device 1, and another smartphone may be used as the operation device 3. For example, the imaging device 1 and the operation device 3 are separated from each other, and a user operates the imaging device 1 using the operation device 3.

The imaging device 1 includes a calculation device 101, an information processing device 102, a primary storage device 103, a secondary storage device 104, an optical device 105, a communication device 108, and a bus 110. The operation device 3 includes a calculation device 301, an information processing device 302, an input device 306, an output device 307, a communication device 308, and a bus 310. The calculation device 301 is a central processing unit (CPU) or the like, the input device 306 is a touch panel, a button, or the like, and the output device 307 is a tactile sense presentation device, a display, or the like. The communication devices 108 and 308 communicate with each other.

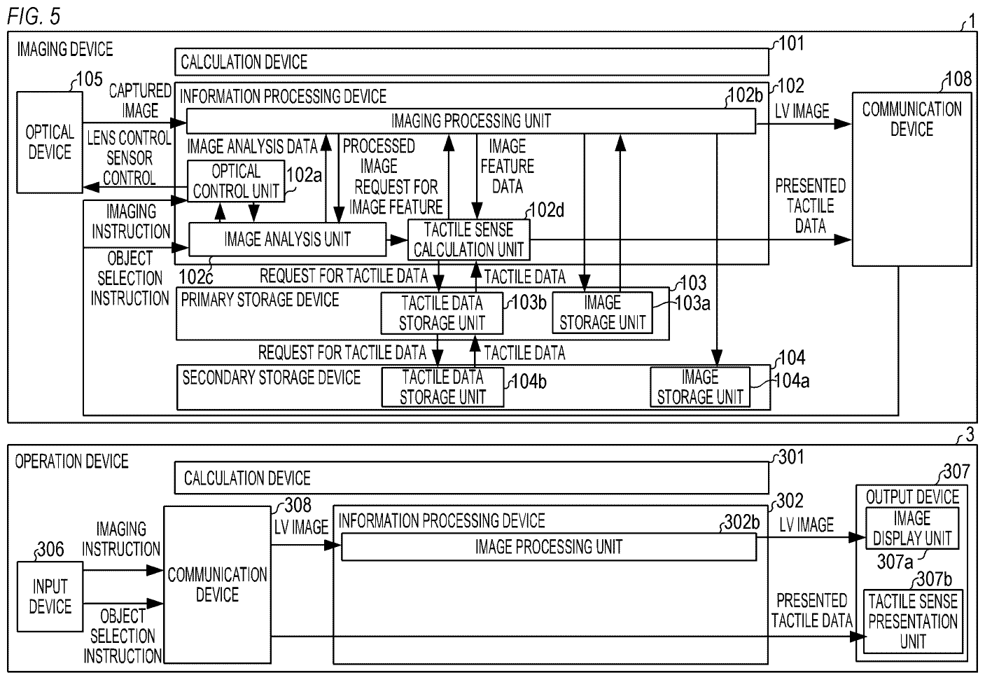

FIG. 5 is a block diagram illustrating a hardware configuration, a functional configuration, and data transmission and reception of the imaging device 1 according to the second embodiment.

A user instruction to the input device 306 is transmitted from the communication device 308 to the communication device 108.

Image data processed by the image processing unit 102b is transmitted from the communication device 108 to the communication device 308. Before communication of the image data, the image processing unit 102b performs a compression process of converting a format of the image data into a format appropriate for the communication. After the communication of the image data, the image processing unit 302b of the information processing device 302 performs a decompression process of converting the format of the image data into a format appropriate for a process in the operation device 3. The image display unit 307a of the output device 307 displays an image (for example, an LV image) based on the decompressed image data.

The presented tactile data generated by the tactile sense calculation unit 102d is transmitted from the communication device 108 to the communication device 308. Before communication of the presented tactile data, the tactile sense calculation unit 102d performs a compression process of converting a format of the presented tactile data into a format appropriate for the communication. After the communication of the presented tactile data, the tactile sense calculation unit 302d of the information processing device 302 performs a decompression process of converting the format of the presented tactile data into a format appropriate for processing in the operation device 3. The tactile sense presentation unit 307b of the output device 307 presents a tactile sense based on the decompressed tactile data.

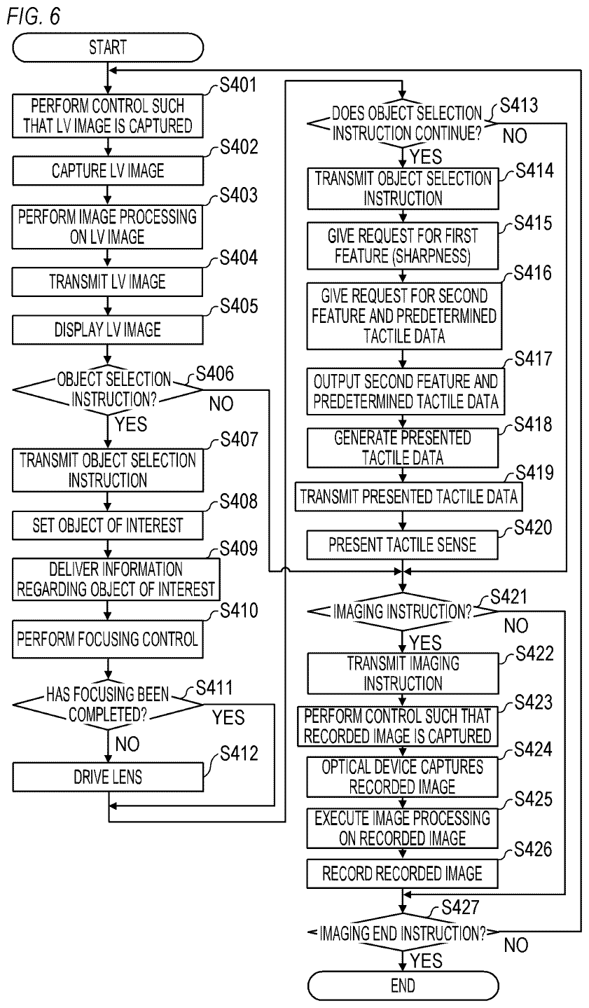

FIG. 6 is a flowchart illustrating an operation of the imaging system according to the second embodiment. When the user operates the input device 306 such as a button or a switch and an operation mode of the imaging system transitions to the imaging mode, the operation of FIG. 6 starts.

Steps S401 to S403 are the same as steps S201 to S203 of FIG. 3. In step S404, the communication device 108 transmits the LV image subjected to the image processing of step S403 to the operation device 3 (the communication device 308). In step S405, the image display unit 307a of the output device 307 displays the LV image transmitted in step S404.

In step S406, the calculation device 301 determines whether an object selection instruction has been given to the input device 306. When the object selection instruction has been given, the process proceeds to step S407. When the object selection instruction has not been given, the process proceeds to step S421. In S407, the communication device 308 transmits the object selection instruction to the imaging device 1 (the communication device 108). Steps S408 to S412 are the same as steps S206 to S210 of FIG. 3.

In step S413, the calculation device 301 determines whether an object selection instruction (touch) to the input device 306 continues. When the object selection instruction continues, the process proceeds to step S414. When the object selection instruction does not continue, the process proceeds to step S421. In S414, the communication device 308 transmits the object selection instruction to the imaging device 1 (the communication device 108). Steps S415 to S418 are the same as steps S212 to S215 of FIG. 3. In step S419, the communication device 108 transmits the presented tactile sense data generated in step S418 to the operation device 3 (the communication device 308). In step S420, the tactile sense presentation unit 307b of the output device 307 presents a tactile sense based on the presented tactile data transmitted in step S419.

In step S421, the calculation device 301 determines whether an imaging instruction has been given to the input device 306. When the imaging instruction has been given, the process proceeds to step S422. When the imaging instruction has not been given, the process proceeds to step S427. In step S422, the communication device 308 transmits an imaging instruction to the imaging device 1 (the communication device 108). Steps S423 to S426 are the same as steps S218 to S221 of FIG. 3. In S427, the calculation device 301 determines whether an imaging end instruction has been given to the input device 306. When the imaging end instruction has been given, the calculation device 301 ends the imaging mode, and the operation of FIG. 6 ends. When the imaging end instruction has not been given, the process proceeds to step S401.

In the second embodiment, it is assumed that the imaging device 1 and the operation device 3 are separated and the imaging device 1 is a freely movable drone or the like. Therefore, in the second embodiment, the imaging situation (first feature data) such as sharpness, the degree of focus, the degree of blur, exposure, sensitivity, a noise level, contrast, the degree of aberration, an image resolution, and the degree of abstraction of the LV image may significantly change as compared with the first embodiment.

Therefore, in the second embodiment, when presented tactile data is generated, first feature data indicating a plurality of features is acquired. Of the plurality of features, a feature to be used is switched such that a feature having a relatively small temporal change (a feature having a temporal change smaller than that of another feature) is used. Similarly, it is assumed that second feature data indicating a plurality of features is acquired. Of the plurality of features, a feature to be used is switched such that a feature having a relatively small temporal change is used. In this way, it is possible to perform stable tactile sense presentation even when an external environment (for example, brightness) significantly changes.

According to the second embodiment described above, in the configuration in which the imaging device and the operation device cooperate with each other, it is possible to perform useful tactile sense presentation similarly to the first embodiment. When the imaging device 1 and the operation device 3 cooperate with each other, a tactile sense can be presented to a user away from the imaging device. Further, by using a feature having a relatively small temporal change, stable tactile sense presentation can be performed even when an external environment significantly changes due to movement of the imaging device or the like.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

For example, data necessary for generating the presented tactile data may be transmitted from the imaging device to an external apparatus such as an operation device, and the presented tactile data may be generated in the external apparatus. The above-described processes may be shared and executed by three or more apparatuses (electronic devices).

The present disclosure is applicable to various electronic devices. For example, the present disclosure may be applied to a personal computer, a smartphone, a tablet terminal, a wearable apparatus (for example, a head mounted display), a digital still camera, a digital video camera, and the like. The present disclosure may be applied to a vehicle (for example, an automobile), an aircraft (for example, a drone), various robots, and the like.

According to the present disclosure, useful tactile sense presentation can be performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-181301, filed Oct. 16, 2024, which is hereby incorporated by reference herein in its entirety.

What is claimed is:

1. An electronic device comprising:
a processor; and
a memory storing a program which, when executed by the processor, causes an electronic device to
execute a determination process of determining a tactile sense to be presented based on a plurality of data regarding imaging,
wherein, in the determination process, a different tactile sense is determined as the tactile sense to be presented depending on an imaging situation.

2. The electronic device according to claim 1,
wherein, in the determination process, the tactile sense to be presented is changed continuously or stepwise with respect to a change in the imaging situation.

3. The electronic device according to claim 1,
wherein the imaging situation includes at least one of first feature data regarding a first feature of an object in a captured image, a mode of an imaging device, a driving situation of the imaging device, a setting of the imaging device, and processing content of the imaging device.

4. The electronic device according to claim 3,
wherein the first feature includes at least one of a degree of focus, a degree of blur, exposure, sensitivity, a noise level, contrast, a degree of aberration, an image resolution, sharpness, and a degree of abstraction of the object.

5. The electronic device according to claim 1,
wherein the plurality of data include at least one of second feature data regarding a second feature of an object in a captured image, predetermined data corresponding to a category of the object, distance data from an imaging device to the object, and predetermined fixed data.

6. The electronic device according to claim 5,
wherein the second feature data includes at least one of recognition result data, color data, brightness data, edge data, and shape data of the object.

7. The electronic device according to claim 3,
wherein the first feature data indicates a plurality of features, and
wherein, in the determination process, a feature to be used is switched to determine the tactile sense to be presented by using a feature having a smaller temporal change than other features among the plurality of features.

8. The electronic device according to claim 1,
wherein, in the determination process, at least one of a frequency, a phase, granularity, hardness, a temperature, a characteristic, a presentation amount, and a presentation time of a tactile sense is determined.

9. The electronic device according to claim 1,
wherein the program, when executed by the processor, further causes the electronic device to execute a presentation process of performing control to present the tactile sense determined by the determination process.

10. The electronic device according to claim 1, further comprising:
an output interface configured to output data indicating the tactile sense to be presented to an external apparatus.

11. The electronic device according to claim 1,
wherein the electronic device is an imaging device.

12. The electronic device according to claim 1,
wherein the electronic device is an external apparatus of the imaging device.

13. An electronic device comprising:
a processor; and
a memory storing a program which, when executed by the processor, causes an electronic device to
execute a determination process of determining a tactile sense to be presented by combining a first tactile sense that is based on a feature of an object in a captured image and a second tactile sense that is determined in advance for the object and has a higher degree of abstraction than the first tactile sense,
wherein, in the determination process, a tactile sense that is closer to the first tactile sense as sharpness of the object in the captured image is higher and is closer to the second tactile sense as the sharpness is lower is determined as the tactile sense to be presented.

14. A control method of an electronic device, comprising:
acquiring a plurality of data regarding imaging; and
determining a tactile sense to be presented based on the plurality of data,
wherein, a different tactile sense is determined as the tactile sense to be presented depending on an imaging situation.

15. A non-transitory computer readable medium that stores a program, wherein the program causes a computer to execute a control method of an electronic device, the control method comprising:
acquiring a plurality of data regarding imaging; and
determining a tactile sense to be presented based on the plurality of data,
wherein, a different tactile sense is determined as the tactile sense to be presented depending on an imaging situation.
